(19) United States
(12) Patent Application Publication
(10) Pub. No.: US 2022/0303722 A1
(43) Pub. Date: Sep. 22, 2022

(54) TRACKING SYSTEM AND METHOD FOR CREATING A VIRTUAL LEASH BETWEEN A MOBILE PHONE AND A PERSONAL ITEM

(71) Applicant: James Satterfield, Gunnison, UT (US)

(72) Inventor: James Satterfield, Gunnison, UT (US)

(21) Appl. No.: 17/691,247

(22) Filed: Mar. 10, 2022

Related U.S. Application Data
(60) Provisional application No. 63/164,090, filed on Mar. 22, 2021.

(51) Int. Cl. H04W 4/02; H04W 4/029; H04M 1/72412; H04W 4/80; G08B 21/24

(52) U.S. Cl. CPC H04W 4/023; H04W 4/029; H04M 1/72412; H04W 4/80; G08B 21/24

(57) ABSTRACT

The present invention relates to a system and method using tracking chips for alerting users of potential loss of their items and assisting users in easily locating such items. A virtual leash is formed between a personal item and a wireless device. The personal item has a tracking chip embedded, or enclosed therein, and the wireless device has an integrated chip. A Bluetooth Low Energy channel is established between the personal item and the wireless device for creating the virtual leash. When the personal item and the wireless device are at a distance near, reaching or exceeding the length of virtual leash from each other, then, the tracking chip vibrates and/or alerts indicating that the wireless device is left behind, lost or misplaced. Similarly, the wireless device also provides alerts to indicate a lost item.

### CROSS-REFERENCE TO RELATED APPLICATION

The present application claims priority to, and the benefit of, U.S. Provisional Application No. 63/164,090, which was filed on Mar. 22, 2021, and is incorporated herein by reference in its entirety.

### FIELD OF THE INVENTION

The present invention relates generally to the tracking devices. More specifically, the present invention relates to a system and method using a tracking chip for alerting users of a potential loss of a personal item by a mobile phone. A tracking chip is embedded, attached to, or enclosed in a personal item and the mobile phone which has a downloaded software application and an integrated chip for creating a virtual leash between the tracking chip and mobile phone. The leash is broken when the personal item and/or the mobile phone are separated from one another at a distance exceeding a predetermined length of the virtual leash. Accordingly, the present disclosure makes specific reference thereto. Nonetheless, it is to be appreciated that aspects of the present invention are also equally applicable to other like applications, devices and methods of manufacture.

### BACKGROUND

By way of background, personal items, such as an ID card, keys, wallet, purse, luggage, and even pets and occasionally children are easily left behind by a user at a location. For example, an individual may commonly leave his or her wallet or purse in the car and need to backtrack to locate the wallet or purse. Similarly, when a user leaves his/her keys in a restaurant, club or a gym, the individual ends up spending considerable time to locate the keys. These personal items are generally compact in size and are difficult to locate as they can fall into gaps or are hidden behind other larger items and are thus not readily visible. Further, when these items are left behind by an individual, a danger is imposed of such items being stolen. A number of problems are created by such scenarios, including not only the time spent to locate a lost item, but also the mental trauma in attempting to find the lost item. People desire a way, or device, that eliminates the loss of personal items and allows users to easily locate the items.

Over the years, numerous attempts have been made at developing cost effective lost-and-found systems for such personal items. In general, lost-and-found services include those which can be utilized by individuals, and have personal contact information of a user to allow the lost-and-found service to contact the user or subscriber when a lost item has been recovered. However, such systems are inherently inefficient and work only to find items after they have been lost and reported to the service. They do not prevent such items from being misplaced or otherwise being separated from the owner. People desire a simple mechanism that prevents them from leaving their important personal items behind when attempting to leave a location where the item is present.

With the advent of use of smartphones, people commonly use their mobile phones while working out in gym, having dinner in a club or restaurant, or even in their vehicle. They may inadvertently leave items when departing from an establishment or other location. People need a device, system or method that can easily alert them of their lost smartphone and eliminates backtracking to locate other lost items.

Therefore, there exist a long-felt need in the art for a device that assists users in locating a lost or stolen mobile phone or another item. There is also a long-felt need in the art for a device that assists users in locating lost or stolen personal items like ID cards, keys, wallets, purses, backpacks and pets. Additionally, there is a long-felt need in the art for device and system that alerts a user about a misplaced or lost mobile phone and/or other personal items. Further, there is a long-felt need in the art for a device and system that eliminates the need for a manual interaction with a lost and found service to locate lost items. Furthermore, there is a long-felt need in the art for a device that can be easily used with any personal item and used for easily locating lost or misplaced items. Finally, there is a long-felt need in the art for a compact, multipurpose device and system that assists users in locating their device or personal items quickly and efficiently and can be embedded or removably attached to personal items.

The subject matter disclosed and claimed herein, in one embodiment thereof, comprises a system for generating alerts in a wireless device and in a tracking chip adhered to, embedded in or attached to a personal item for alerting users about potential loss of the personal item. The system includes a tracking chip adhered to a personal item and a chip integrated in the wireless device forming a virtual leash, using a Bluetooth channel between the tracking chip and the integrated chip. The leash is created by calculating a length equaling a predetermined distance. The length may be changed from item to item depending on the type of item to be tracked. The tracking chip includes a vibration module and an alarm module for vibrating the chip on the personal item and generating an alarm when the personal item and wireless device are at a distance exceeding the predetermined distance from the tracking chip.

In this manner, the system and the tracking chips of the present invention accomplishes all of the foregoing objectives and provides individuals with an effective way of alerting users about potential loss of personal items and mobile phones. Also, vibration and alerts allow the users to easily locate items and assist the individuals in locating their device or personal items quickly and efficiently

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a method for detecting and alerting when a wireless device has moved a distance greater than a predetermined distance from a tracking chip. The method includes the steps of initially calculating a suitable length for the item and then establishing a virtual leash between a chip integrated in a wireless device and the tracking chip. The virtual leash has a length equal to the predetermined distance. Next, the tracking chip receives regular Bluetooth beacons from the integrated chip; transmitting a signal from the tracking chip, and acknowledging the Bluetooth signals to the integrated chip. Then, generating by the tracking chip, a vibration and an audible or visual alert when the wireless device is at a distance greater than the predetermined distance from the tracking chip.

In a further embodiment of the present invention, a tracking chip is configured to be embedded, attached to or adhered to a personal item is disclosed. The tracking chip is designed to create a virtual leash between a handheld electronic device for alerting a user when the electronic device is left behind, lost, or misplaced or exceeds a predetermined distance. The tracking chip further includes a vibration module for vibrating the personal item; an alarm module for generating an audible or visual alarm; a location module for detecting location of the item; a battery for providing power to the vibration module and the alarm module; and a Bluetooth module for establishing a Bluetooth channel forming the virtual leash with the handheld electronic device such that the vibration, and audible or visual alarm are generated when the electronic device moves a distance exceeding the virtual leash length away from the tracking chip.

In yet another embodiment of the present invention, a system for generating alerts in a wireless device and tracking chip disposed on a personal item when the wireless device and the tracking chip are separated by at least a predetermined distance is disclosed. The system includes a tracking chip adhered, or attached to or embedded in a personal item, and a chip integrated in the wireless device. A virtual leash is formed using a Bluetooth channel between the tracking chip and the integrated chip with a length equaling the predetermined distance. The tracking chip includes a vibration module and an alarm module for vibrating the personal item and generating an alarm when the wireless device is at a distance exceeding the predetermined distance from the tracking chip.

In yet another embodiment, the integrated chip provides an alert to the user via the wireless device.

In yet another embodiment, the integrated chip and the tracking chip have same configuration and provide same functionalities.

In yet another embodiment of the present invention, a method for providing a virtual leash between a personal item and a wireless device for alerting a user when the wireless device and/or personal item is misplaced or lost is described. The method includes the steps of regularly transmitting, Bluetooth beacons from the wireless device to a tracking chip connected to the personal item; and receiving, by the wireless device, Bluetooth acknowledgement signals from the tracking chip. Detecting, by the wireless device, a weak Bluetooth signal; and generating an alert, by the wireless device, for alerting a user that the virtual leash is broken.

The advantage of the system and method of the present invention is that it alerts users when a personal item, with tracking chip, and the wireless device are separated by an amount at least as great as a predetermined distance. Different signals can be generated as the distance between the phone and the item are in one of the positions of getting closer to the predetermined distance, for example between 2 and 10 percent of the final distance, when the phone and item have achieved the predetermined distance, between 0 percent and 2 percent of the final distance and a further audible sound when the smartphone and item are at a distance greater than the predetermined distance such as 0.1 percent more than the prescribed distance. Vibration and alerts assist users in locating their device or personal items quickly and efficiently.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 is a functional block diagram view of a tracking chip of the present invention in accordance with the disclosed architecture;

FIG. 2 illustrates a schematic diagram showing a system formed between the tracking chip and electronic/wireless device using Bluetooth connection in accordance with the disclosed architecture;

FIG. 3 illustrates a functional block diagram of the integrated chip embedded into the wireless device for creating a virtual leash with the tracking chip in accordance with the disclosed architecture;

FIG. 4 illustrates a schematic view of another embodiment of the implementation of the virtual leash and lost and found system of the present invention in accordance with the disclosed architecture;

FIG. 5 illustrates a flow diagram depicting a process of communication between the wireless device and the tracking chip in accordance with the disclosed architecture;

FIG. 6 illustrates a flow diagram depicting a process of pairing the tracking chip and the integrated chip of the wireless device for creating the virtual leash in accordance with the disclosed architecture;

FIG. 7 illustrates a flow diagram depicting another process of pairing the tracking chip and the integrated chip of the wireless device for creating the virtual leash in accordance with the disclosed architecture; and

FIG. 8 illustrates a perspective view of a key with attached tracking chip in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive 6escryiption of the invention and do not limit the scope of the invention. Additionally, an illustrated embodiment need not have all the aspects or advantages shown. Thus, in other embodiments, any of the features described herein from different embodiments may be combined.

As noted above, there exist a long-felt need in the art for a system that assists users in locating a lost or stolen mobile phone or other items. There is also a long-felt need in the art for a device that assists users in locating lost or stolen personal items like ID cards, keys, wallets, purses, pets, and even people. Additionally, there is a long-felt need in the art for a device and system that alerts a user about a misplaced or lost mobile phone and/or personal item(s). Further, there is a long-felt need in the art for a device and system that eliminates the need for a manual interaction or a subscription with a lost and found service to locate lost items. Furthermore, there is a long-felt need in the art of a device that can be easily used with any personal item(s) and used for easily locating such lost items. Finally, there is a long-felt need in the art for a compact, multipurpose device and system that assists users in locating their device or personal items quickly and efficiently and can be embedded, attached or adhered to, or removably attached to personal items.

The present invention, in one exemplary embodiment, is a novel tracking chip configured to be embedded or adhered to a personal item for alerting users of potential loss of a wireless (electronic) device. The tracking chip is designed to create a virtual leash with a handheld electronic device for alerting a user when the electronic device is left behind, lost, or misplaced. The tracking chip further includes a vibration module for vibrating the personal item; an alarm module for generating an audible or visual alarm; and a location module for detecting location of said item. A battery is provided for providing power to the vibration module and the alarm module; and a Bluetooth module is used for establishing a Bluetooth channel forming the virtual leash with the handheld electronic device and item such that the vibration, and audible or visual alarms are generated when the electronic device moves a distance approaching, meeting or exceeding the virtual leash length when measured from the tracking chip.

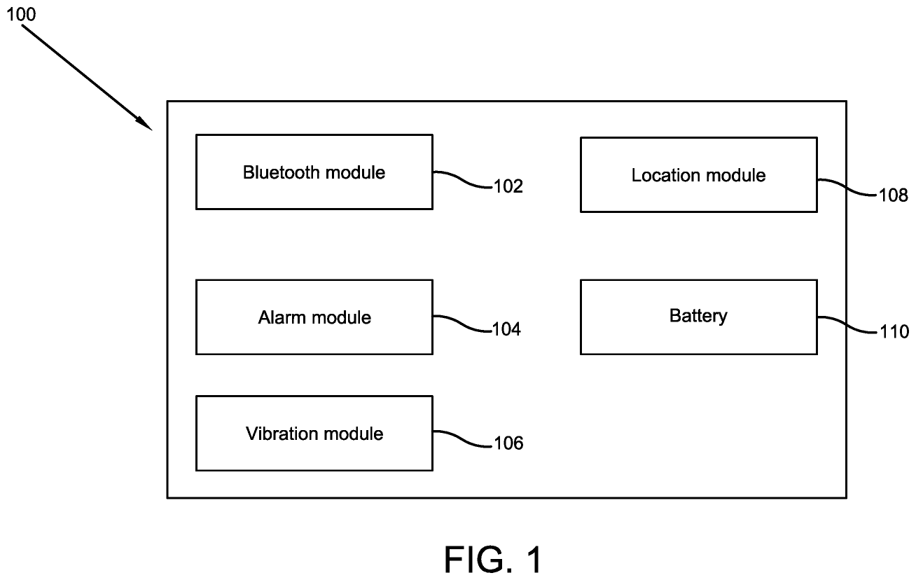

Referring initially to the drawings, FIG. 1 is a functional block diagram view of a tracking chip 100 of the present invention in accordance with the disclosed specification. The tracking chip 100 is the designed in the form of a small flexible chip or sticker that can be attached or enclosed within, or on, a personal item or object, such as, a wallet, ID card, keys, toy, pet, purse, backpack, vehicle, or any other object or individual that the user wants to track. The tracking chip 100 is also configured to establish a Bluetooth communication with a handheld electronic device allowing the user to easily track and locate an item having the embedded or attached tracking chip 100.

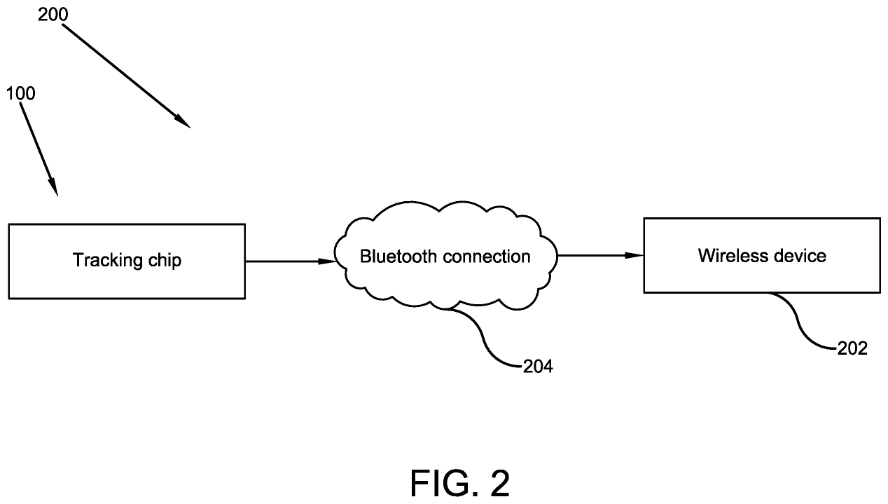

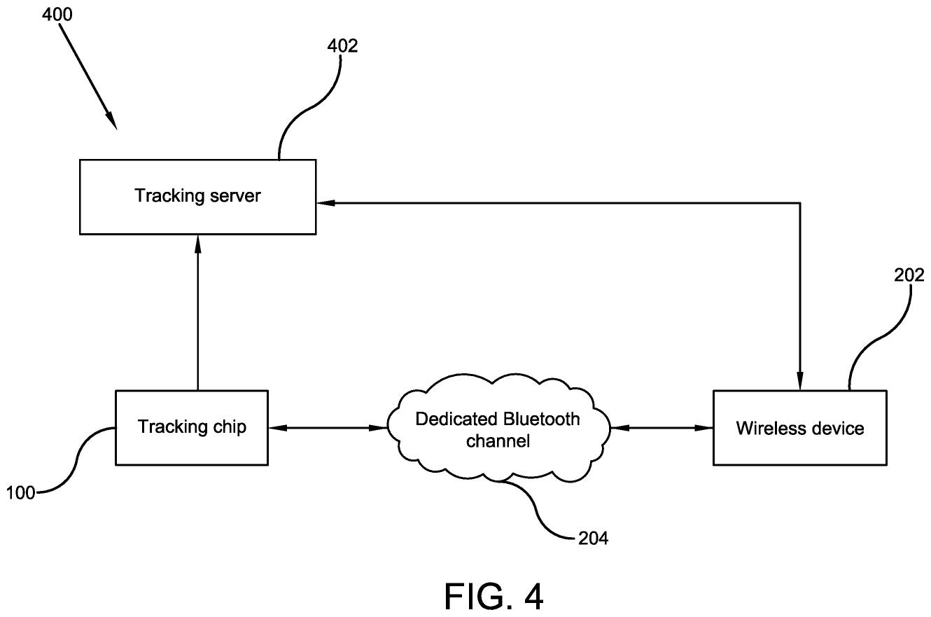

More specifically, the tracking chip 100 includes a Bluetooth module 102 for establishing a Bluetooth or Bluetooth Low Energy (BLE) channel with an electronic device 202 (as shown in FIG. 2) and with a tracking server as shown in FIG. 4. The Bluetooth channel and connection between the tracking chip 100 and the paired electronic device act as a virtual leash preventing both the tracking chip 100 (and the item on which the chip 100 is embedded or attached) and the electronic device from being lost. The virtual leash maintains a connection between the tracking chip 100 and the electronic device up to a threshold distance, and a reasonable distance beyond the threshold distance. When the threshold distance is neared or exceeded, then, the chip 100 and/or the electronic device provide a notification, thereby preventing tracking chip 100 and/or electronic device from being lost, left behind or misplaced.

An alarm module 104 embedded in the chip 100 is configured to produce an audible and/or visual alarm to indicate status of the connected or leashed electronic or wireless device. The alarm module 104 is activated when the virtual leash is broken with the electronic device nearing or exceeding the threshold distance to maintain the virtual leash.

A vibration module 106 of the chip 100 vibrates the chip 100 and the item on which the chip 100 is embedded, or attached thereto, allowing a user to notify and receive the status of the connected or leashed electronic or wireless device. The vibration module 106 is activated when the virtual leash is broken with the electronic device nearing and/or exceeding the threshold distance established by the virtual leash.

A location module 108 is a GPS chip that provides longitude and latitude attributes of location of the chip 100. The GPS chip may be used for sending location information to a tracking server and also to a mobile device as an additional way of locating a lost chip 100. A battery 110, in the form of a button battery, is used for providing power to the chip 100. It should be noted that the chip 100 is a low-power device and the battery 110 can provide power up to six months. Alternatively, the chip may obtain energy from the transmission signal to allow the chip to power up and transmit a signal back to the electronic device.

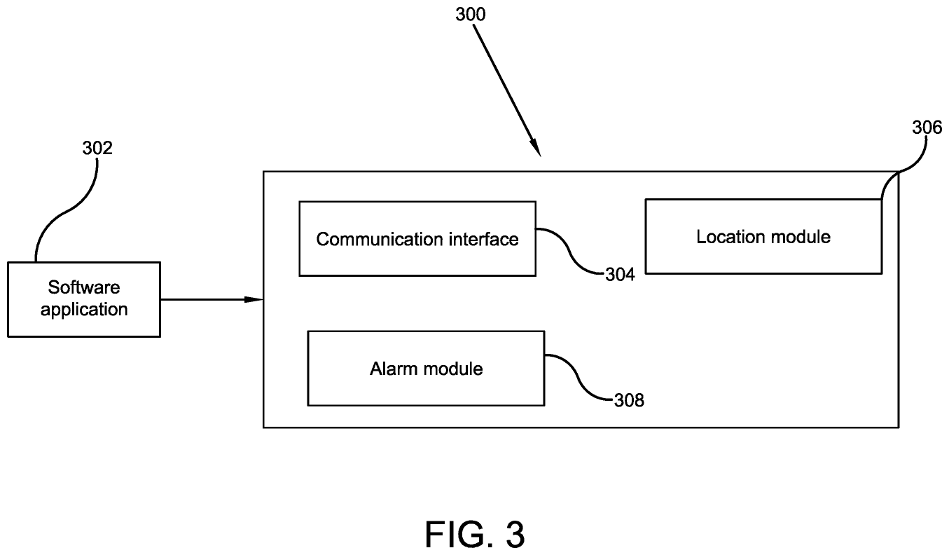

FIG. 2 illustrates a schematic diagram showing a system 200 formed between the tracking chip 100 and electronic or wireless device 202 using a Bluetooth connection in accordance with the disclosed specification. As illustrated, in the present system 200, the tracking chip 100 is connected to the wireless device 202 using a Bluetooth connection 204 formed between the Bluetooth module 102 (shown in FIG. 1) and a communication interface of the wireless device 202. The Bluetooth connection 204 forms a virtual leash that virtually binds the chip 100 and wireless device 202 up to a threshold distance (for example, range of Bluetooth Low Energy (“BLE”) signal) as determined by the system capabilities and other wireless systems able to support the transmission of a signal. BLE is in the 2.4 GHz band and uses about 40 channels with each channel being about 2 MHz wide. More specifically, the chip 100 is configured to receive Bluetooth signal packets transmitted from an integrated chip (shown in FIG. 3) of the wireless device 202 and when the wireless device 202 moves away from the chip 100 to a distance greater than the threshold distance, then, the chip 100 starts providing alarms and alerts indicating that the virtual leash is broken and the wireless device 202 may be misplaced, lost or out of range. Simultaneously, the wireless device 202 also provides alerts indicating that the wireless device 202 has broken the leash and is lost, misplaced or out of range which would tell the user he or she needs to move the item back within range if the user knows the location of the item.

It should be noted that the wireless device 202 may also have an integrated chip for maintaining the leash and providing alerts. Using the system of the present invention, both the chip 100 and the wireless device 202 provide alerts allowing a user to easily locate an item with an embedded chip 100 and/or the wireless device 202.

Advantageously, the system allows the user to be alerted when the wireless device 202 is left behind or misplaced by vibrating a personal item having the embedded chip 100. The system can be set to issue alerts as the distance is nearing the predetermined threshold distance, at the threshold distance or beyond the threshold distance.

FIG. 3 illustrates a functional block diagram of integrated chip 300 embedded into wireless device 202 for creating a virtual leash with the tracking chip 100 in accordance with the disclosed specification. The wireless device 202 has an integrated chip 300 embedded into the motherboard of the device 202. Alternatively, the chip 300 can be attached to the back surface of the wireless device 202 thereby allowing users to use a virtual leash with existing mobile phones. The chip 300 can also be configured using a software application 302 installed in the mobile device prior to use. The application 302 is a computer implemented software application that can be used for configuring the range of a virtual leash.

More specifically, the integrated chip 300 communicates with the tracking device 100 using the Bluetooth channel to create a virtual leash. The integrated chip 300 has a communication interface 304 that may allow the integrated chip 300 to maintain the virtual leash even when the wireless device 202 is switched off. The integrated chip 300 also has a location module 306, in the form of a GPS chip, that is used for detecting the location of the wireless device 202 to which the chip 300 is mounted. An alarm module 308 generates vibration and an audible alarm to indicate that the virtual leash with a tracking chip 100 is broken. The alarms can be set to work simultaneously with one another, substantially simultaneously or sequentially with one another. Alternatively, only audible alarms may be used, or vibration alarms, depending on the preference of the user.

It should be noted that functionality of the integrated chip 300 and the tracking chip 100 can be same. Also, the tracking chip 100 can be integrated in the wireless device.

FIG. 4 illustrates a schematic view of another embodiment of the implementation of virtual leash and lost and found system of the present invention in accordance with the disclosed specification. In the present embodiment of the system 400, the tracking chip 100 and the wireless device 202, having the integrated chip 300, maintain a virtual leash using the Bluetooth channel 204.

A tracking server 402 is configured as a local server at a location where the virtual leash is established and connects to both the tracking chip 100 and the integrated chip 300 of the wireless device 202. When the virtual leash maintained between the tracking chip 100 and the wireless device 202 breaks, both the tracking chip 100 and the integrated chip 300 transmit their location to the tracking server 402. The tracking server 402 then sends location of the tracking chip 100 to the wireless device 202, thereby allowing a user to view the location of the tracking chip 100 in the smartphone application.

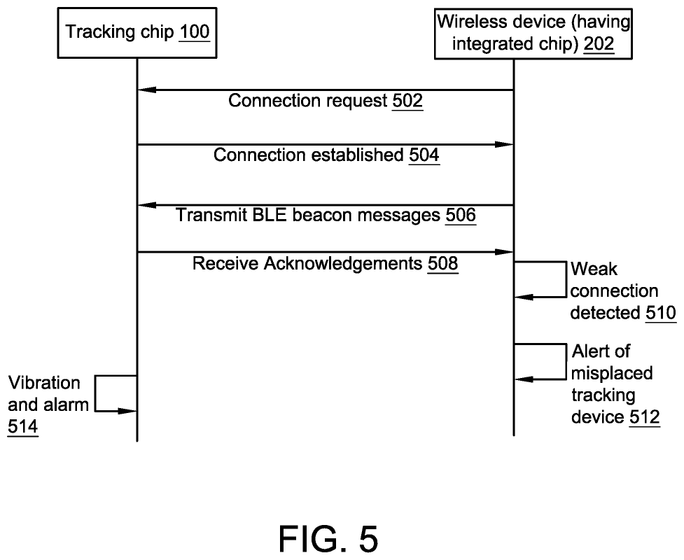

FIG. 5 illustrates a flow diagram depicting a process of communication between the wireless device 202 and the tracking chip 100 in accordance with the disclosed specification. As illustrated, initially a connection request 502 is transmitted from the tracking chip to the wireless device (Step 502). An alternative embodiment, the connection request 502 may also be transmitted from the wireless device 202 to the tracking chip 100. When the connection request 502 is accepted, then, a successful connection is established between the chip 100 and the wireless device 202.

Thereafter, the wireless device 202 (via the integrated chip 300) transmits BLE beacon messages to the connected tracking chip 100 (Step 506). The chip 100 continuously transmits acknowledgement beacons to the wireless device 202 for maintaining the virtual leash (Step 508). When the wireless device 202 (via the integrated chip 300) starts moving far from the chip 100, then the integrated chip 300 starts detecting a weak BLE signal (Step 510). Once the wireless device 202 moves away from the range of virtual leash, an alert, in the form of at least one of a vibration, audible or a message, is provided by the wireless device 202 (Step 512). The chip 100 also starts vibrating (thereby vibrating the item to which the chip 100 is mounted) enabling a user to detect the wireless device 202 and/or the tracking device 100 (and the personal item) if lost, left behind or misplaced (Step 514).

As an example, when a user carries a wallet having the enclosed tracking chip 100 but forgets the wireless device 202, then the wallet vibrates and provides alerts thereby notifying the user of a lost, misplaced or left behind wireless device.

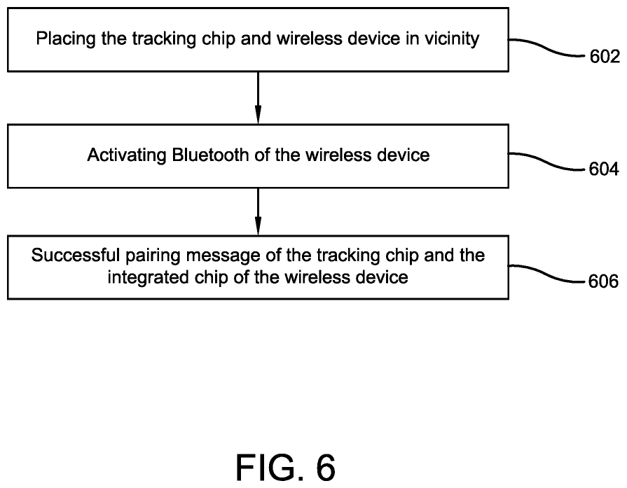

FIG. 6 illustrates a flow diagram depicting a process of pairing the tracking chip 100 and the integrated chip of the wireless device for creating the virtual leash in accordance with the disclosed specification. For pairing, the tracking chip 100 and the wireless device 202 with integrated chip 300 are placed in vicinity of each other (Step 602). Thereafter, Bluetooth of the wireless device is activated (Step 604). Finally, on successfully transfer of BLE messages, pairing becomes successful and thus a virtual leash is established between the tracking chip 100 and the wireless device 202 (Step 606).

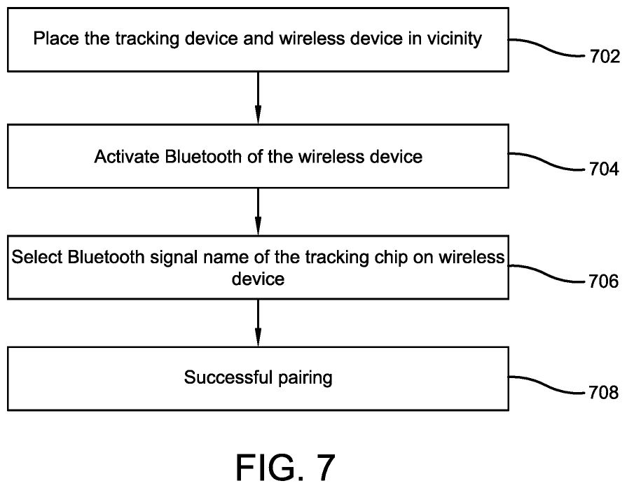

FIG. 7 illustrates a flow diagram depicting another process of pairing the tracking chip 100 and the integrated chip of the wireless device for creating the virtual leash in accordance with the disclosed architecture. Initially, the tracking chip 100 and the wireless device 202 with integrated chip 300 are placed in vicinity of each other (Step 702). Thereafter, Bluetooth of the wireless device is activated (Step 704). Then, on the software application of the wireless device, Bluetooth signal name of the tracking chip is selected (Step 706). On selecting the signal name, the integrated chip 300 and the tracking chip 100 are paired to create a virtual leash having a defined range. The user may establish additional parameters in the defined range creating zones which will trigger the type of alarm to be received based on where the item is in the defined range. The audible or vibratory alarms may be continuous, intermittent or have some combination of timing or use of the alarms.

It should be noted that using the software application, the integrated chip can be paired with a plurality of tracking chips and the mobile device user can configure which tracking chip to leash via the wireless device.

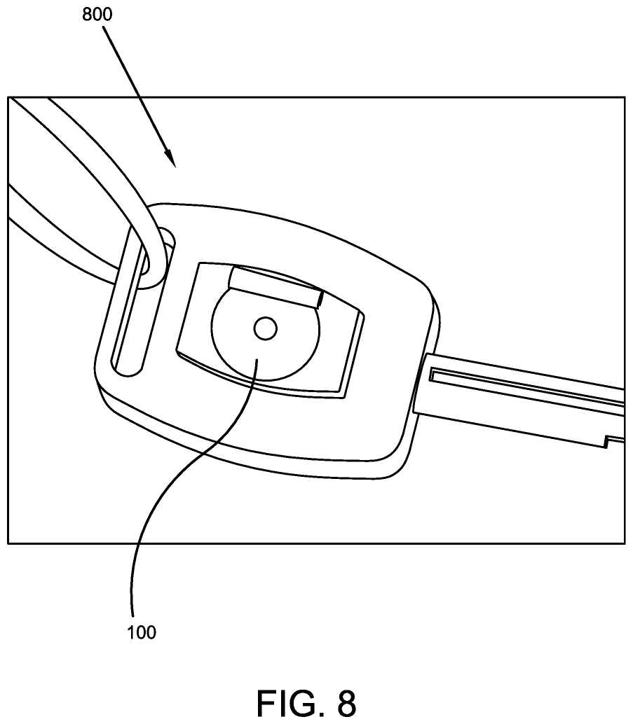

FIG. 8 illustrates a perspective view of a key 800 with attached tracking chip 100 in accordance with the disclosed architecture. As illustrated, the key 800 has the attached tracking chip 100 thereby allowing the key 800 to be tracked using the wireless device 202 (of FIG. 2) and also allowing a user to be notified about a misplaced wireless device 202.

The chip 100 can be embedded, attached to, or adhered to the key 800. The chip 100 can be of any shape and size and can be removably placed on the key 800 allowing the chip 100 to be used with any personal item as per preference of the user. Various fastening systems can be used to attach the chip 100 to the item 800, such as hook and loop fasteners, adhesive, including repositionable, removable as well as permanent or activatable adhesives, or combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “tracking chip”, “tracking device”, and “chip” are interchangeable and refer to the tracking chip 100 of the present invention. Similarly, as used herein “lost and found system” and “system” are interchangeable and refer to the lost and found system 200,400 of the present invention.

Notwithstanding the forgoing, the tracking chip 100 and the lost and found system 200,400 of the present invention can be of any suitable size and configuration as is known in the art without affecting the overall concept of the invention, provided that, it accomplishes the above-stated objectives. One of ordinary skill in the art will appreciate that the tracking chip 100 and the lost and found system 200,400, as shown in the FIGS., are for illustrative purposes only, and that many other sizes and shapes of the tracking chip 100 and the lost and found system 200,400 are well within the scope of the present disclosure. Although the dimensions of the tracking chip 100 and the lost and found system 200,400 are important design parameters for user convenience, the tracking chip 100 and the lost and found system 200,400 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system for tracking an item, the system comprising:
a smartphone having a downloaded software application and a smartphone chip for transmitting and receiving a signal;
at least one item having a chip that is capable of receiving and sending signals; and
a predetermined length defining a range for which the at least one item and the smartphone can be positioned in relation to one another to transmit and receive the signal.

2. The system as recited in claim 1, wherein each of the smartphone chip and the chip is a Bluetooth Low Energy (BLE) chip.

3. The system as recited in claim 1, wherein the smartphone emits an alarm when the at least one item is in one position of nearing, reaching or extending outside of the predetermined length.

4. The system as recited in claim 3, wherein the alarm is at least one of an audible or a vibratory alarm.

5. The system as recited in claim 4, wherein the at least one of the audible or the vibratory alarm may be continuous, intermittent or have some combination of timing or use.

6. The system as recited in claim 3, wherein the alarm is generated when the at least one item is in the last 2 to 10 percent of the predetermined distance as the at least one item is nearing the predetermined distance.

7. The system as recited in claim 3, wherein the alarm is generated when the at least one item is within 0 and 2 percent of the predetermined distance.

8. The system as recited in claim 3, wherein the alarm is generated when the at least one item is at a distance of 0.1 percent greater than the predetermined distance.

9. The system as recited in claim 1, wherein the predetermined distance is a distance equal to a transmission of a BLE chip.

10. The system as recited in claim 1, wherein the predetermined distance creates a virtual leash between the at least one item and the smartphone.

11. The system as recited in claim 10 further comprising a tracking server connected to each of the smartphone and the at least one item, for transmission of a location to the tracking server.

12. The system as recited in claim 11, wherein the tracking server transmits a location of the smartphone to the at least one item, and the tracking server transmits the location of the at least one item to the smartphone.

13. A method of connecting a smartphone to at least one item, the method comprising the steps of;
providing the smartphone with a first BLE chip
providing at least one item containing a second BLE chip that is embedded in, attached to or adhered to the at least one item;
transmitting a connection request from the smartphone to the second BLE chip;
accepting the transmission of the smartphone and the at least one item;
establishing a connection between the smartphone and the at least one item; and
transmitting a signal from the at least one item to the smartphone.

14. The method as recited in claim 13 further comprising a step of establishing a predetermined distance between the smartphone and the at least one item after the step of transmitting a connection request.

15. The method as recited in claim 14 further comprising a step of generating an alarm if the predetermined distance is neared, reached or exceeded after the step of establishing.

16. The method as recited in claim 14, wherein the alarm is at least one of an audible alarm or a vibratory alarm.

17. A method of establishing a virtual leash between a wireless device and at least one item, the method comprising the steps of:
providing the wireless device with a first BLE chip;
connecting a second BLE chip to the at least one item;
transmitting a signal from each of the at least one item and the wireless device to a tracking server;
establishing a connection between the at least one item and the wireless device; and
creating a distance for defining a virtual leash between the wireless device and the at least one item.

18. The method as recited in claim 17 further comprising a step of generating an alarm if the at least one item and the wireless device exceed the distance of the virtual leash after the step of creating the distance.

19. The method as recited in claim 17 further comprising a step of accepting the signal from each of the at least one item and the wireless device after the step of transmitting.

20. The method as recited in claim 17 further comprising a step of pairing the first BLE chip and the second BLE chip after the step of transmitting by placing the wireless device and the at least one item in a vicinity of one another.
